(19) United States
(12) Patent Application Publication
(10) Pub. No.: US 2006/0273670 A1
(43) Pub. Date: Dec. 7, 2006

(54) MOTOR STATOR

(76) Inventors: Chao-Nien Tung, Shenzhen (CN); Chuen-Shu Hou, Shenzhen (CN); Chih-Hao Yang, Shenzhen (CN); Lung-Wei Huang, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,600

(22) Filed: Apr. 11, 2006

(30) Foreign Application Priority Data
Jun. 3, 2005 (CN) 200510035128.2

(51) Int. Cl. H02K 7/00; H02K 1/12

(52) U.S. Cl. 310/67 R; 310/257

(57) ABSTRACT

A motor stator (10) includes a hollow cylinder (19), a stator winding (16) and upper and lower magnetic pole plates (12, 18). The stator winding is axially wound around the hollow cylinder. The upper and lower magnetic pole plates are disposed at opposite sides of the stator winding. At least one of the upper and lower magnetic pole plates has a plurality of projecting fins (122, 182) extending from a periphery thereof. The upper and lower magnetic pole plates are made from ferromagnetic powder having a plurality of particles each having a core-shell structure with a central core (52) and an outer shell (54) coated on the central core. The central core is made of a magnetic material. The outer shell has a higher electrical resistance than the central core.

### CROSS-REFERENCES TO RELATED APPLICATION

Relevant subject matter is disclosed in copending U.S. patent application filed on the same date and having a same title with the present application, and copending U.S. patent application filed on the same date and having a title “ferromagnetic powder for dust core”, both of which are assigned to the same assignee with the present application.

### FIELD OF THE INVENTION

The present invention relates generally to motors, and more particularly to a motor stator for use in a brushless motor, such as a fan motor.

### DESCRIPTION OF RELATED ART

It is well known that rotary motors are widely used to drive devices such as cooling fans, hard disc drives, etc. A rotary motor includes therein two important components—stator and rotor. The rotor rotates relative to the stator due to a magnetic interaction between them. For example, in a computer system, a fan motor is used to drive an impeller of a cooling fan so as to produce airflows flowing towards a heat generating electronic component such as a central processing unit (CPU) whereby the CPU is cooled. The impeller is affiliated to the rotor of the fan motor and moves continuously to generate the airflows due to rotation of the rotor.

FIG. 10 illustrates a conventional cooling fan including a stator 100 and a rotor 200 rotatably mounted to the stator 100. The stator 100 includes a stator core made of a plurality of laminated silicon steel sheets 101 around which a stator coil (not labeled) is wound. The silicon steel sheets 101, which are typically prepared by stamping silicon steel sheets, have an eddy current loss that is proportional to the square of the thickness of each of the silicon steel sheets 101. The eddy current loss is brought about by the production of an eddy current in the stator core induced by a magnetic field acting on the stator core. Thus, the silicon steel sheets 101 are expected to have a thickness as small as possible in order to reduce the eddy current loss associated therewith. However, since the stamping process has a minimum thickness requirement for the silicon steel sheets 101 and excessively thin lamination structures are prone to deformation during assembly, the silicon steel sheets 101 are often selected to have a thickness of 0.20 mm, 0.35 mm or 0.50 mm. The eddy current loss in the lamination core prepared from the laminated steel sheets 101 is relatively high. Furthermore, the shape for the lamination core is also unduly limited. Certain shapes or configurations are very difficult and expensive to achieve with the silicon steel laminations.

Therefore, it is desirable to provide a motor stator wherein one or more of the foregoing disadvantages may be overcome or at least alleviated.

### SUMMARY OF INVENTION

The present invention relates to a motor stator for use in a brushless motor such as a fan motor. The motor stator includes a hollow cylinder, a stator winding and upper and lower magnetic pole plates. The stator winding is axially wound around the hollow cylinder along an axial direction of the hollow cylinder. The upper and lower magnetic pole plates are disposed at opposite sides of the stator winding. At least one of the upper and lower magnetic pole plates has a plurality of projecting fins extending from a periphery thereof. The upper and lower magnetic pole plates are made from a ferromagnetic powder with a plurality of particles each having a core-shell structure with a central core and an outer shell coated on the central core. The central core is made of a magnetic material and is used for providing magnetic property for the upper and lower magnetic pole plates. The outer shell has a higher electrical resistance than the central core and is used for increasing insulation and enhancing interconnection between the particles of the ferromagnetic powder.

Other advantages and novel features of the present invention will become more apparent from the following detailed description of preferred embodiment when taken in conjunction with the accompanying drawings, in which:

### BRIEF DESCRIPTION OF DRAWINGS

FIG. 1 is an isometric view of a motor stator in accordance with a first embodiment of the present invention;

FIG. 2 is an assembled view of the motor stator of FIG. 1;

FIG. 3 is an isometric view of a motor stator in accordance with a second embodiment of the present invention;

FIG. 4 is an isometric view of a motor stator in accordance with a third embodiment of the present invention;

FIG. 5 is an assembled view of the motor stator of FIG. 4;

FIG. 6 is an isometric view of a motor stator in accordance with a fourth embodiment of the present invention;

FIG. 7 is a schematic representation of a particle of ferromagnetic powder suitable for production of the motor stator of FIGS. 1-6;

FIG. 8 is a schematic representation showing a particle of the ferromagnetic powder in accordance with an alternative example;

FIG. 9 is a schematic representation showing a particle of the ferromagnetic powder in accordance with another example; and

FIG. 10 is a cross-sectional view of a cooling fan in accordance with the conventional art.

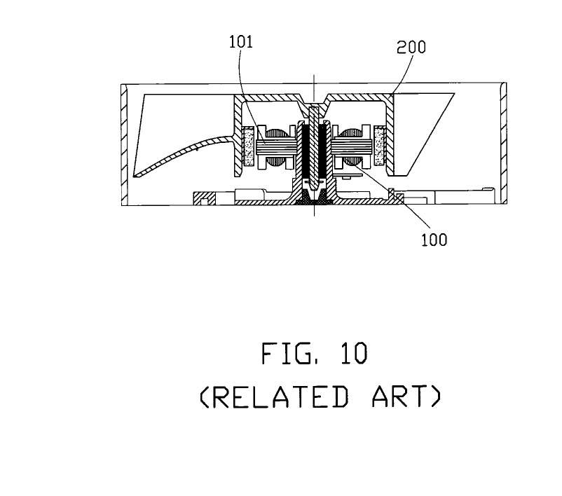

### DETAILED DESCRIPTION

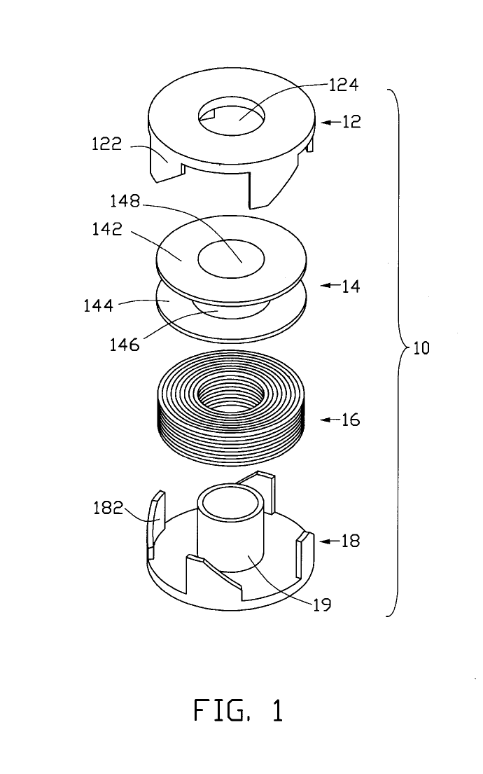

FIG. 1 illustrates a motor stator 10 in accordance with a first embodiment of the present invention. The motor stator 10 includes upper and lower magnetic pole plates 12, 18, an insulating member 14, a stator winding 16 and a hollow cylinder 19. The upper magnetic pole plate 12 defines a central opening 124 and has a plurality of projecting fins 122 extending downwardly from a circumference thereof. The lower magnetic pole plate 12 has a plurality of projecting fins 182 extending upwardly from a circumference thereof. Evenly distributed over the circumference of the magnetic pole plate 12 (18), these projecting fins 122 (182) each have a varied length from a fixed side to a free side thereof, whereby a slanted edge is formed at the free side. In the illustrated embodiment, the magnetic pole plate 12 (18) has four projecting fins 122 (182). The hollow cylinder 19 is integrally formed with the lower magnetic pole plate 18 and extends upwardly from a central portion thereof. The insulating member 14, having a H-shaped configuration as viewed from a side perspective of FIG. 1, includes two parallel (upper and lower) plane portions 142, 144 and a central, hollow portion 146 interconnecting the upper and lower plane portions 142, 144. The hollow portion 146 defines therein a through hole 148 for reception of the hollow cylinder 19. The upper and lower plane portions 142, 144 and the hollow portion 146 cooperatively define an annular external receiving space (not labeled) for accommodating the stator winding 16 therein.

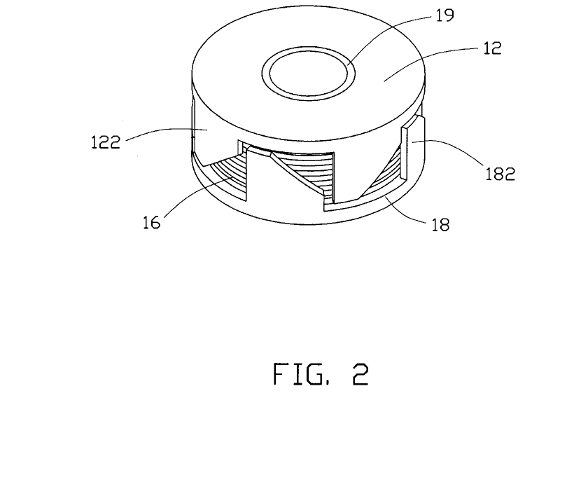

With reference also to FIG. 2, in assembly, the upper and lower magnetic pole plates 12, 18 are respectively assembled on opposite sides of the insulating member 14 in an axial direction. The hollow cylinder 19 is inserted into and received in the through hole 148 of the insulating member 14 and the central opening 124 of the upper magnetic pole plate 12. A top free end portion of the hollow cylinder 19 is flush with a top surface of the upper magnetic pole plate 19. The upper and lower magnetic pole plates 12, 18 are faced towards each other with the projecting fins 122, 182 of the two magnetic pole plates 12, 18 surrounding the stator winding 16, as shown in FIG. 2, wherein the projecting fins 122 of the upper magnetic pole plate 12 are positioned alternately with respect to the projecting fins 182 of the lower magnetic pole plate 18. The stator winding 16 is wound axially on an outer circumference of the hollow portion 146 of the insulating member 14. The stator winding 16 is thus located between the hollow cylinder 19 and the projecting fins 122, 182 of the upper and lower magnetic pole plates 12, 18.

The illustrated motor stator 10 can be suitably used as a stator for a brushless motor, such as a fan motor, thereby substituting for the conventional stator prepared from laminated silicon steel sheets. The upper and lower magnetic pole plates 12, 18 and the hollow cylinder 19, with cooperation of the stator winding 16, generate a magnetic field for rotating a rotor which is rotatably mounted to the motor stator 10. The hollow cylinder 19 operates to receive shaft, ball bearings or sleeve bearings, or other necessary accessories of the formed brushless motor of which the motor stator 10 is a part. The projecting fins 122, 182 formed on the upper and lower magnetic pole plates 12, 18, alternated with each other and provided with slanted edges at free sides thereof, are used to effectively guide rotation of the rotor.

In order to electrically insulate the stator winding 16 from the upper and lower magnetic pole plates 12, 18 and the hollow cylinder 19, an outer surface of each of these components 12, 18, 19 may be coated with a layer of electrical insulating material, in which case the stator winding 16 may be directly wound on an outer circumference of the hollow cylinder 19 and the insulating member 14 can be omitted, thereby simplifying the structure of the motor stator 10.

According to the first embodiment, the upper and lower magnetic pole plates 12, 18 each have a plurality of projecting fins formed thereon. Alternatively, the projecting fins may be formed at only one of the upper and lower magnetic pole plates 12, 18, and the other magnetic pole plate 12 or 18 is not provided with projecting fins.

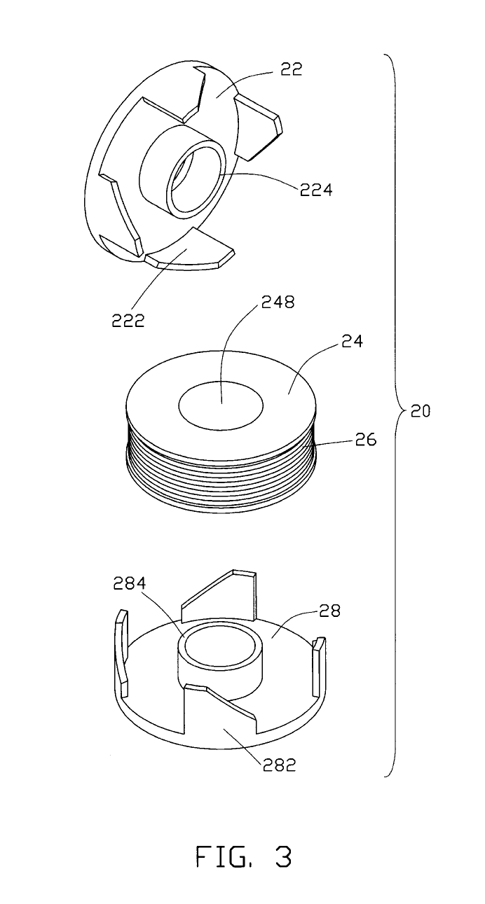

FIG. 3 illustrates a motor stator 20 in accordance with a second embodiment of the present invention. The motor stator 20 includes upper and lower magnetic pole plates 22, 28, an insulating member 24 and a stator winding 26 axially wound around the insulating member 24. The insulating member 24 defines therein a through hole 248. A plurality of evenly spaced projecting fins 222 extends downwardly from a periphery of the upper magnetic pole plate 22. A hollow cylinder 224 is integrally formed with the upper magnetic pole plate 22 and extends downwardly from a central portion of the upper magnetic pole plate 22. Likewise, the lower magnetic pole plate 28 has a plurality of projecting fins 282 extending upwardly from a periphery thereof and a hollow cylinder 284 extending upwardly from a central portion thereof. A height dimension of the insulating member 24 is substantially a sum of height dimensions of the two hollow cylinders 224, 284, which are extended from the upper and lower magnetic pole plates 22, 28, respectively. In assembly, the two hollow cylinders 224, 284 are inserted from opposite sides of the insulating member 24 into the through hole 248 and received therein. The upper and lower magnetic pole plates 22, 28 are maintained to face towards each other, with the projecting fins 222, 282 of the two magnetic pole plates 22, 28 being alternately distributed around the stator winding 26.

In order to electrically insulate the stator winding 26 from the upper and lower magnetic pole plates 22, 28 and the hollow cylinders 224, 284, an outer surface of each of these components 22, 28, 224, 284 may be coated with a layer of electrical insulating material, in which case the stator winding 26 may be directly wound on outer circumferences of the hollow cylinders 224, 284 and the insulating member 24 can be omitted, thereby simplifying the structure of the motor stator 20.

According to the second embodiment, the upper and lower magnetic pole plates 22, 28 each have a plurality of projecting fins formed thereon. Alternatively, the projecting fins can be provided at only one of the upper and lower magnetic pole plates 22, 28, and the other magnetic pole plates 22 or 28 is not provided with projecting fins.

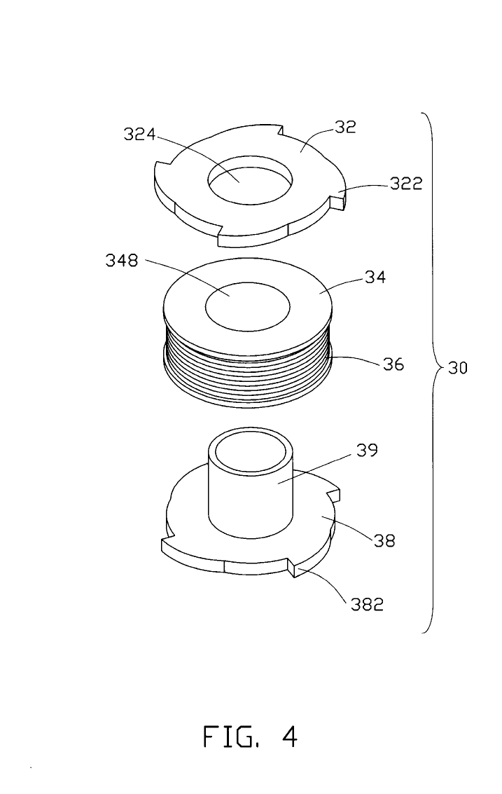

FIG. 4 illustrates a motor stator 30 in accordance with a third embodiment of the present invention. The motor stator 30 includes upper and lower magnetic pole plates 32, 38, an insulating member 34, a stator winding 36, and a hollow cylinder 39. The stator winding 36 is axially wound around the insulating member 34. The insulating member 34 defines therein a through hole 348. The upper magnetic pole plate 32 defines therein a central opening 324 and has a plurality of projecting fins 322 extending radially outwardly from a periphery thereof. The lower magnetic pole plate 38 has a plurality of projecting fins 382 extending radially outwardly from a periphery thereof. Being evenly distributed over the circumference of the magnetic pole plate 32 (38), these projecting fins 322 (382) each have a projected size from the magnetic pole plate 32 (38) varied along a width of the projecting fin 322 (382), whereby each of the projecting fins 322 (382) has an arced edge at a free side thereof. The hollow cylinder 39 is integrally formed with the lower magnetic pole plate 38, and extends upwardly from a central portion of the lower magnetic pole plate 38.

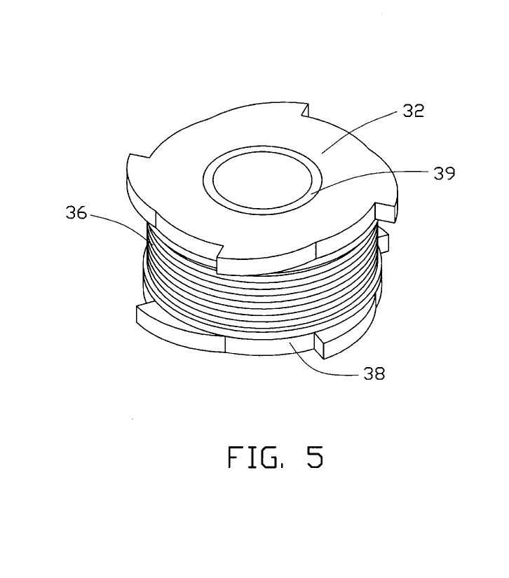

With reference to FIGS. 4-5, in assembly, the hollow cylinder 39 is inserted into and received in the through hole 348 of the insulating member 34 and the central opening 324 of the upper magnetic pole plate 32. A top free end portion of the hollow cylinder is flush with a top surface of the upper magnetic pole plate. The projecting fins 322 of the upper magnetic pole plate 32 are arranged alternately with respect to the projecting fins 382 of the lower magnetic pole plate 38.

In order to electrically insulate the stator winding 36 from the upper and lower magnetic pole plates 32, 38 and the hollow cylinder 39, an outer surface of each of these components 32, 38, 39 may be coated with a layer of electrical insulating material, in which case the stator winding 36 may be directly wound on an outer circumference of the hollow cylinder 39 and the insulating member 34 can be omitted, thereby simplifying the structure of the motor stator 30.

According to the third embodiment, the upper and lower magnetic pole plates 32, 38 each have a plurality of projecting fins formed thereon. Alternatively, the projecting fins can be provided at only one of the upper and lower magnetic pole plates 32, 38, and the other magnetic pole plates 32 or 38 is not provided with projecting fins.

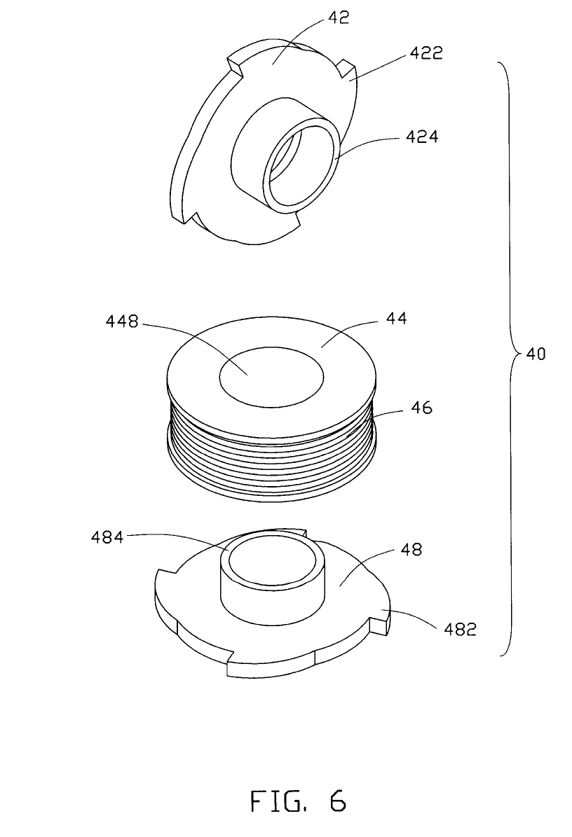

FIG. 6 illustrates a motor stator 40 in accordance with a fourth embodiment of the present invention. The motor stator 40 includes upper and lower magnetic pole plates 42, 48, an insulating member 44 and a stator winding 46 axially wound around the insulating member 44. The insulating member 44 defines therein a through hole 448. A plurality of evenly spaced projecting fins 422 extends radially outwardly from a periphery of the upper magnetic pole plate 42. A hollow cylinder 424 is integrally formed with the upper magnetic pole plate 42 and extends downwardly from a central portion of the upper magnetic pole plate 42. Likewise, the lower magnetic pole plate 48 has a plurality of projecting fins 482 extending radially outwardly from a periphery thereof, and a hollow cylinder 484 extending upwardly from a central portion thereof. A height dimension of the insulating member 44 is substantially a sum of the height dimensions of the two hollow cylinders 424, 484, which extend from the upper and lower magnetic pole plates 42, 48, respectively. In assembly, the two hollow cylinders 424, 484 are inserted from opposite sides of the insulating member 44 into the through hole 448 and received therein. The upper and lower magnetic pole plates 42, 48 are maintained to face towards each other, wherein the projecting fins 422, 482 of the two magnetic pole plates 42, 48 are alternately arranged.

In order to electrically insulate the stator winding 46 from the upper and lower magnetic pole plates 42, 48 and the hollow cylinders 424, 484, an outer surface of each of these components 42, 48, 424, 484 may be coated with a layer of electrical insulating material, in which case the stator winding 46 may be directly wound on outer circumferences of the hollow cylinders 424, 484 and the insulating member 44 can be omitted, thereby simplifying the structure of the motor stator 40.

According to the fourth embodiment, the upper and lower magnetic pole plates 42, 48 each have a plurality of projecting fins formed thereon. Alternatively, the projecting fins may be provided at only one of the upper and lower magnetic pole plates 42, 48, and the other magnetic pole plates 42 or 48 is not provided with projecting fins.

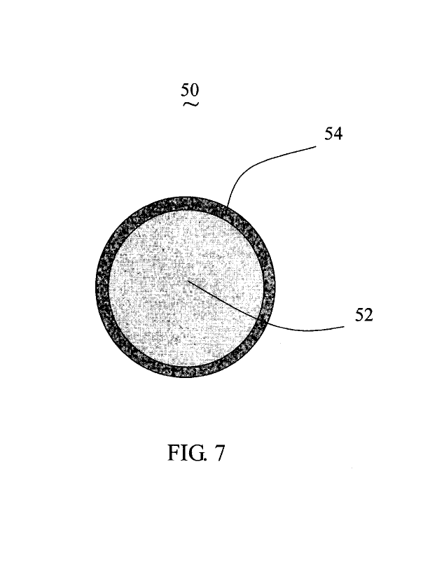

Each of the above-mentioned magnetic pole plates 12, 18, 22, 28, 32, 38, 42 and 48 is integrally made from ferromagnetic powder by, for example, powder metallurgy technique, wherein the powder metallurgy technique is a process of making parts by pressing powdered particles in die presses. FIG. 7 schematically illustrates a particle 50 of ferromagnetic powder which is suitable for forming the magnetic pole plates 12, 18, 22, 28, 32, 38, 42 and 48. The particle 50 has a core-shell structure, which includes a central core 52 made of a magnetic material and an outer shell 54 coated on the central core 52. The outer shell 54 is a thin layer covering an outer circumference of the central core 52. The outer shell 54 has a higher electrical resistance than the central core 52. The shape of the particle 50 is subject to no limitations, which may be spherical, flat or other suitable shapes. The average diameter for the particle 50 is 5 to 150 μm if the particle 50 is spherical.

The magnetic material used for the central core 52 is typically selected from a soft magnetic material of high magnetic permeability and low magnetic loss, such as soft magnetic metals, amorphous iron-based magnetic powder, pure iron powder, iron-based powder compositions, soft magnetic non-metals and the like. For example, magnetic powder such as iron, sendust, ferrosilicon, permalloy, supermalloy, iron nitride, iron-aluminum alloys and iron-cobalt alloys may be suitable for the central core 52. Among these magnetic materials mentioned above, iron or iron-based powders having high saturation magnetization are preferred when the powders are used to prepare the stator core consisting of the upper magnetic pole plate 12 (22, 32, 42) and the lower magnetic pole pate 18 (28, 38, 48) as a substitute for the conventional stator core prepared from silicon steel laminations.

The outer shell 54 of the particle 50 is made from such materials as to enable the outer shell 54 to have an electrical resistance that is higher than that of the central core 52 for the purpose of reducing an eddy current loss associated with the stator core made from the ferromagnetic powder. In this embodiment, such materials include, without limitation, metal composites and piezoelectric materials.

As an example, the particle 50 of the core-shell structure is prepared by employing a diffusion/precipitation mechanism, based on powder sintering process. Specifically, the soft magnetic material for the central core 52 such as iron is melted firstly and the coating material as used to form the outer shell 54 is then added to the melted magnetic material to form a mixture. By using an atomizing or pulverization method, small powder is accordingly prepared from the mixture. Then the obtained powder is sintered at a temperature of about 300° C. to about 900° C. to cause the coating material contained in the powder to become supersaturated and accordingly precipitate out from the remaining magnetic material in the powder. As such, the precipitated coating material forms as the outer shell 54 for the particle 50 and the magnetic material forms as the central core 52 for the particle 50.

In another example, the central core 52 is previously obtained by, for example, an atomizing method from a soft magnetic material such as iron. A thin layer of film having a higher electrical resistance than the central core 52 is then deposited on the outer surface of the core 52, wherein the film operates as the outer shell 54. Such deposition method may be physical vapor deposition (PVD) or chemical vapor deposition (CVD). The material used for depositing of the film may be ferrites, piezoelectric materials, ferroelectric materials or ceramic materials.

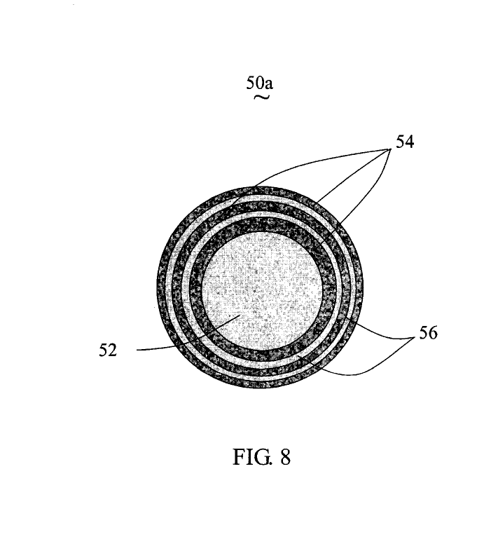

FIG. 8 schematically illustrates an alternative example of a particle 50a of the ferromagnetic powder, in which the particle 50a have a multi-layer structure. As shown in this example, the particle 50a includes a central core 52 and multiple layers of outer shells 54 concentrically surrounding the central core 52, wherein the outmost part of the particle 50a is an outer shell 54. Every two adjacent shells 54 are spaced apart by a magnetic layer 56 made of a magnetic material. The material for the magnetic layers 56 includes soft magnetic metals, amorphous iron-based magnetic powder, pure iron powder and composites thereof, soft magnetic non-metals and the like. In this embodiment, the central core 52 and the magnetic layers 56 are made of the same magnetic material.

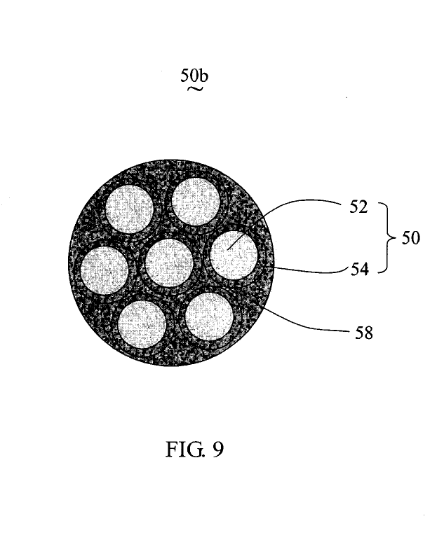

FIG. 9 schematically illustrates a further example of a particle 50b of the ferromagnetic powder, in which multiple particles 50 are combined together by a binder 58 to form the particle 50b which has a larger size than the particle 50 of FIG. 7. Each of the base particles 50 includes a central core 52 and an outer shell 54 coated on the central core 52. In this embodiment, the binder 58 and the shells 54 are made of the same material.

As the ferromagnetic powder described above is used to produce the magnetic pole plates 12, 18, 22, 28, 32, 38, 42 and 48, the ferromagnetic powder is pressure molded at a high temperature, for example, in the range of 300 to 800 centigrade degrees. After the ferromagnetic powder is molded into a semi-finished product, the compact can be desirably annealed to release the strain induced during the pressure molding process to obtain a final product for the magnetic pole plates 12, 18, 22, 28, 32, 38, 42 and 48.

Alternatively, these magnetic pole plates 12, 18, 22, 28, 32, 38, 42 and 48 can be made from the ferromagnetic powder by metal injection molding. Specifically, the ferromagnetic powder is mixed with a binder such as wax-polymer binder and then is injected into a mold. After molding, the wax-polymer binder is removed, usually by heat, and then the structure is sintered in a manner similar to powder metallurgy.

The central core 52 and the magnetic layer 56 in the ferromagnetic powder provide the necessary magnetic property for the magnetic pole plates 12, 18, 22, 28, 32, 38, 42 and 48 made from the ferromagnetic powder, while the outer shell 54 or the binder 58 operates to improve a bonding strength between the particles 50 (50a, 50b) as the ferromagnetic powder is pressure molded into the magnetic pole plates 12, 18, 22, 28, 32, 38, 42 and 48. The outer shell 54 or the binder 58 permits adjacent ferromagnetic particles 50 (50a, 50b) to strongly bond together. The outer shell 54 and the binder 58 also enhance insulation between adjacent ferromagnetic particles 50 (50a, 50b), thereby decreasing the eddy current loss for the final products. Therefore, the motor stator 10 (20, 30 or 40) made from the above-illustrated ferromagnetic powder exhibits a high magnetic flux density, low eddy current loss, as well as high mechanical strength.

The motor stator 10 (20, 30 or 40) can be suitably used as a substitute for the conventional motor stator having a stator core made from laminated silicon steel sheets. In the conventional motor stator, the silicon steel sheets for the stator core are typically prepared by stamping silicon steel sheets, in which case the material yield is extremely low since waste material is unavoidable from the stamping operation. By using the powder metallurgy process or the metal injection molding process, the material yield is 100%, and it is possible to produce stator cores with relatively complex shapes.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A motor stator comprising:
a hollow cylinder;
a stator winding axially wound around the hollow cylinder along an axial direction of the hollow cylinder; and
upper and lower magnetic pole plates disposed at opposite sides of the stator winding, at least one of the upper and lower magnetic pole plates having a plurality of projecting fins extending from a periphery thereof, the upper and lower magnetic pole plates being made from ferromagnetic powder consisting of a plurality of particles each having a core-shell structure with a central core and an outer shell coated on the central core wherein the central core is made of a magnetic material and configured for providing magnetic property for the upper and lower magnetic pole plates while the outer shell is configured for providing a bonding strength between the particles of the ferromagnetic powder, the outer shell having a higher electrical resistance than the central core to reduce an eddy current loss associated with the upper and lower magnetic pole plates.

2. The motor stator of claim 11 wherein the hollow cylinder is integrally formed with one of the upper and lower magnetic pole plates.

3. The motor stator of claim 2, further comprising an additional hollow cylinder integrally formed with the other of the upper and lower magnetic pole plates.

4. The motor stator of claim 1, further comprising an insulating member surrounding the hollow cylinder and located between the upper and lower magnetic pole plates, the stator winding being wound on an outer circumference of the insulating member.

5. The motor stator of claim 1, wherein the projecting fins extend in said axial direction and are evenly distributed over the periphery of the magnetic pole plate from which the projecting fins extend.

6. The motor stator of claim 1, wherein the projecting fins extend radially outwardly and are evenly distributed over the periphery of the magnetic pole plate from which the projecting fins extend.

7. The motor stator of claim 1, wherein the upper and lower magnetic pole plates each have said plurality of projecting fins, the projecting fins of the upper magnetic pole plate being arranged alternately with respect to the projecting fins of the lower magnetic pole plate.

8. The motor stator of claim 11 wherein at least one of the projecting fins has a varied size from a fixed side thereof in connection with the periphery of the at least one of the upper and lower magnetic pole plates to a free side thereof opposite the fixed side.

9. The motor stator of claim 1, wherein the magnetic material for the central core is selected from a group consisting of soft magnetic metal, amorphous iron-based magnetic powder, pure iron powder, iron-based powder compositions and soft magnetic non-metal.

10. The motor stator of claim 11 wherein a material for the outer shell is selected from a group consisting of metal composite and piezoelectric material.

11. The motor stator of claim 11 wherein the each particle further includes an additional shell surrounding the central core and outer shell, a magnetic layer being sandwiched between the additional shell and the outer shell.

12. The motor stator of claim 1, wherein the each particle is combined with at least another particle by a binder to form an integral structure.

13. A motor stator comprising:
a stator winding defining an axial direction, the stator winding having opposite sides in said axial direction; and
a magnetic pole plate disposed at one of said opposite sides, the magnetic pole plate being integrally made from ferromagnetic powder with a plurality of particles each having a core-shell structure, wherein a central core of the core-shell structure is constructed from a material selected from a group consisting of soft magnetic metal, amorphous iron-based magnetic powder, pure iron powder, iron-based powder compositions and soft magnetic non-metal, and an outer shell of the core-shell structure is constructed from a material selected from a group consisting of metal composite and piezoelectric material, the outer shell having a higher electrical resistance than the central core.

14. The motor stator of claim 13, further comprising an additional magnetic pole plate disposed at the other of said opposite sides, at least one of the magnetic pole plates having a plurality of projecting fins extending from a periphery thereof.

15. The motor stator of claim 14, further comprising a hollow cylinder with the stator winding being wound around the hollow cylinder in said axial direction.

16. A motor stator comprising:
a cylindrical insulating member having a recess defined in a circumferential periphery thereof;
a coil winding surrounding the insulating member and received in the recess;
an upper magnetic pole plate fixed to a top end of the insulating member and consisting of a plurality of first particles connected together, at least one of the first particles comprising a central core made of magnetic material and a shell enclosing the central core, the shell having a higher electrical resistance than the central core, the upper magnetic pole plate comprising a plurality of first fins extending downwardly to surround the coil winding; and
a lower magnetic pole plate fixed to a bottom end of the insulating member and consisting of a plurality of second particles connected together, at least one of the second particles comprising a central core made of magnetic material and a shell enclosing the central core, the shell of the at least one of the second particles having a higher electrical resistance than the central core thereof, the lower magnetic pole plate comprising a plurality of second fins extending upwardly to surround the coil winding and being alternate with the first fins.

17. The motor stator of claim 16, wherein the at least one of the first particles further has a magnetic layer enclosing the shell thereof, and an outer shell enclosing the magnetic layer, wherein the magnetic layer and the central core of the at least one of the first particles are made of a same material, while the outer shell and the shell of the at least one of the first particles are made of a same material.

18. The motor stator of claim 17, wherein the at least one of the first particles is combined with at least another one of the first particles by a binder enclosing the at least one and the at least another one of the first particles.

19. The motor stator of claim 18, wherein the binder and the shells of the at least one and the at least another one of the first particles are made of a same material.
